(19) United States
(12) Patent Application Publication
(10) Pub. No.: US 2018/0108281 A1
(43) Pub. Date: Apr. 19, 2018

(54) ELECTRONIC BALLAST SYSTEM FOR SIGNAGE LIGHT

(71) Applicant: DELTA ELECTRONICS, INC., Taoyuan City (TW)

(72) Inventors: Yung-Chuan Lu, Taoyuan City (TW); Ching-Ho Chou, Taoyuan City (TW)

(21) Appl. No.: 15/474,422

(22) Filed: Mar. 30, 2017

(30) Foreign Application Priority Data
Oct. 14, 2016 (CN) 201610897790.7

(51) Int. Cl. G09F 13/00; H05B 33/08; H05B 41/392; H05B 41/295

(52) U.S. Cl. CPC G09F 13/005; H05B 33/083; H05B 41/295; H05B 41/3925; H05B 33/0815

(57) ABSTRACT

An electronic ballast system for signage light includes a first lamp string, a second lamp string, a first inverter and a second inverter. The first lamp string includes at least one first lamp tube. The second lamp string is connected with the first lamp string in series, and includes at least one second lamp tube. The first inverter is connected with the first lamp string for driving illumination of the first lamp string. The second inverter is connected with the second lamp string for driving illumination of the second lamp string. A frequency difference between a frequency of the first inverter and a frequency of the second inverter is in a range between 500 Hz and 5 kHz.

### FIELD OF THE INVENTION

The present invention relates to an electronic ballast system, and more particularly to a small-sized electronic ballast system for signage light for avoiding a lamp flicker problem. The loads can be fluorescent lamps or LED lamps.

### BACKGROUND OF THE INVENTION

Nowadays, electronic ballasts are widely used. In comparison with inductive ballasts, the electronic ballasts have superior performance.

Generally, the conventional electronic ballast comprises a single inverter (e.g., full-bridge circuit). The single inverter is used for driving a lamp string comprising plural serially-connected lamp tubes or a lamp string comprising plural parallel-connected lamp tubes. As the number of the connected lamp tubes in the lamp string increases, the conventional electronic ballast has to output a higher ignition voltage or ignition current, and the output power of the single inverter also increases. Under this circumstance, the volume of the magnetic element (e.g., a transformer or an inductor) in the conventional electronic ballast becomes larger, which causes the conventional electronic ballast detrimental to the miniaturization requirements of the modern electronic product.

For solving the above drawback, partial electronic ballasts make efforts in the volume reduction of the electronic ballast by designing dual-inverter. However, the dual-inverter makes a lamp flicker problem occurs. For avoiding the lamp flicker problem, the electronic ballast is further equipped with a phase-locked control circuit or the overall circuitry is modified. Consequently, the fabricating cost of the electronic ballast increases or the circuitry becomes complicated.

Therefore, there is a need of providing an improved electronic ballast system for signage light in order to eliminate the above drawbacks.

### SUMMARY OF THE INVENTION

The present invention provides an electronic ballast system for signage light with reduced volume, reduced fabricating cost and simplified circuitry.

In accordance with an aspect of the present invention, there is provided an electronic ballast system for signage light. The electronic ballast system for signage light includes a first lamp string, a second lamp string, a first inverter and a second inverter. The first lamp string includes at least one first lamp tube. The second lamp string is connected with the first lamp string in series, and includes at least one second lamp tube. The first inverter is connected with the first lamp string for driving illumination of the first lamp string. The second inverter is connected with the second lamp string for driving illumination of the second lamp string. A frequency difference between a frequency of the first inverter and a frequency of the second inverter is in a range between 500 Hz and 5 kHz.

In accordance with another aspect of the present invention, there is provided an electronic ballast system for signage light. The electronic ballast system for signage light includes a first lamp string, a second lamp string, a first inverter and a second inverter. The first lamp string includes at least one first lamp tube. The second lamp string is connected with the first lamp string in series, and includes at least one second lamp tube. A first filament preheating coil is shared by one of the at least one first lamp tube of the first lamp string and one of the at least one second lamp tube of the second lamp string. The first inverter is connected with the first lamp string for driving illumination of the first lamp string. The second inverter is connected with the second lamp string for driving illumination of the second lamp string. There is a frequency difference between a frequency of the first inverter and a frequency of the second inverter.

In accordance with a further aspect of the present invention, there is provided an electronic ballast system for signage light. The electronic ballast system for signage light includes a first lamp string, a second lamp string, a first inverter and a second inverter. The first lamp string includes at least one first lamp tube. The second lamp string is connected with the first lamp string in series, and includes at least one second lamp tube. A first filament preheating coil is shared by one of the at least one first lamp tube of the first lamp string and one of the at least one second lamp tube of the second lamp string. The first inverter is connected with the first lamp string for driving illumination of the first lamp string. The second inverter is connected with the second lamp string for driving illumination of the second lamp string. There is a frequency difference between a frequency of the first inverter and a frequency of the second inverter. The first inverter and the second inverter are half-bridge isolated inverters.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating an electronic ballast system for signage light according to an embodiment of the present invention;

FIG. 2 is a schematic simulated waveform diagram illustrating the current of the lamp tube of the first lamp string or the second lamp string connected to the shared first filament preheating coil and the current of the other lamp tubes, in which the first inverter and the second inverter shown in FIG. 1 are asynchronously operated at the identical frequency;

FIG. 3 is a schematic simulated waveform diagram illustrating the current of the lamp tube of the first lamp string or the second lamp string connected to the shared first filament preheating coil and the current of the other lamp tubes, in which the first inverter and the second inverter shown in FIG. 1 are asynchronously operated at different frequencies;

FIG. 4 is a schematic circuit block diagram illustrating a variant example of the electronic ballast system for signage light of FIG. 1;

FIG. 5 is a schematic circuit block diagram illustrating another variant example of the electronic ballast system for signage light of FIG. 1;

FIG. 6 is a schematic circuit block diagram illustrating an electronic ballast system for signage light according to another embodiment of the present invention; and

FIG. 7 is a schematic circuit block diagram illustrating a variant example of the electronic ballast system for signage light of FIG. 6.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

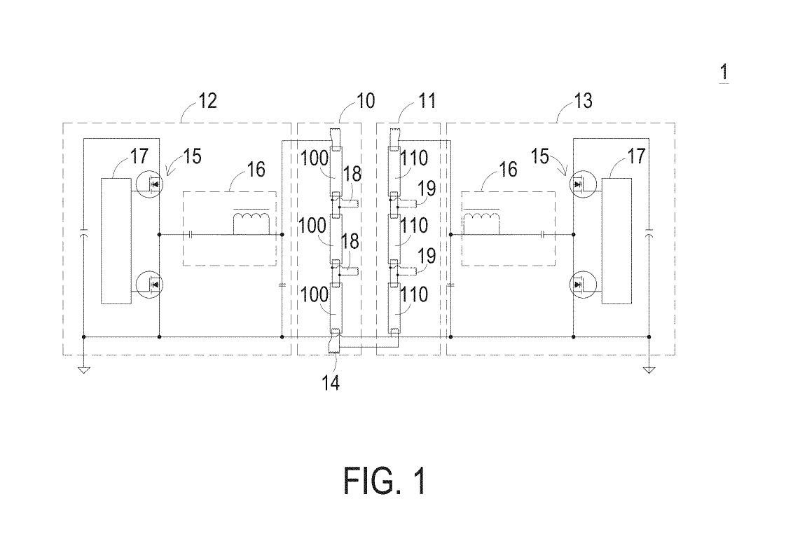

FIG. 1 is a schematic circuit block diagram illustrating an electronic ballast system for signage light according to an embodiment of the present invention. As shown in FIG. 1, the electronic ballast system for signage light 1 comprises a first lamp string 10, a second lamp string 11, a first inverter 12 and a second inverter 13. The first lamp string 10 comprises at least one first lamp tube 100. As shown in FIG. 1, the first lamp string 10 comprises three first lamp tubes 100 connected in series. The second lamp string 11 is connected with the first lamp string 10 in series. The second lamp string 11 comprises at least one second lamp tube 110. As shown in FIG. 1, the second lamp string 11 comprises three second lamp tubes 110. Moreover, a first filament preheating coil 14 is shared by one of the three first lamp tubes 100 of the first lamp string 10 and one of the three second lamp tubes 110 of the second lamp string 11. As shown in FIG. 1, the first filament preheating coil 14 is shared by the bottommost first lamp tube 100 of the first lamp string 10 and the bottommost second lamp tube 110 of the second lamp string 11.

The first inverter 12 is electrically connected with the first lamp string 10 for driving illumination of the first lamp string 10. The second inverter 13 is electrically connected with the second lamp string 11 for driving illumination of the second lamp string 11.

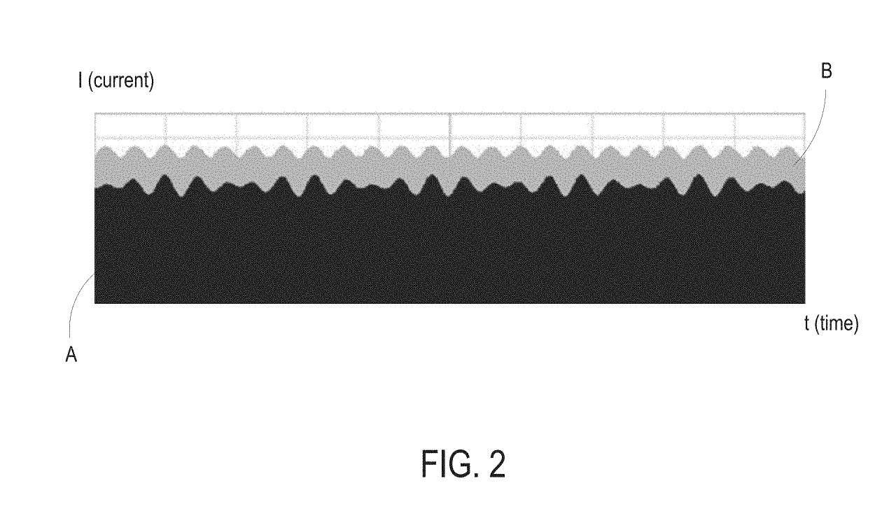

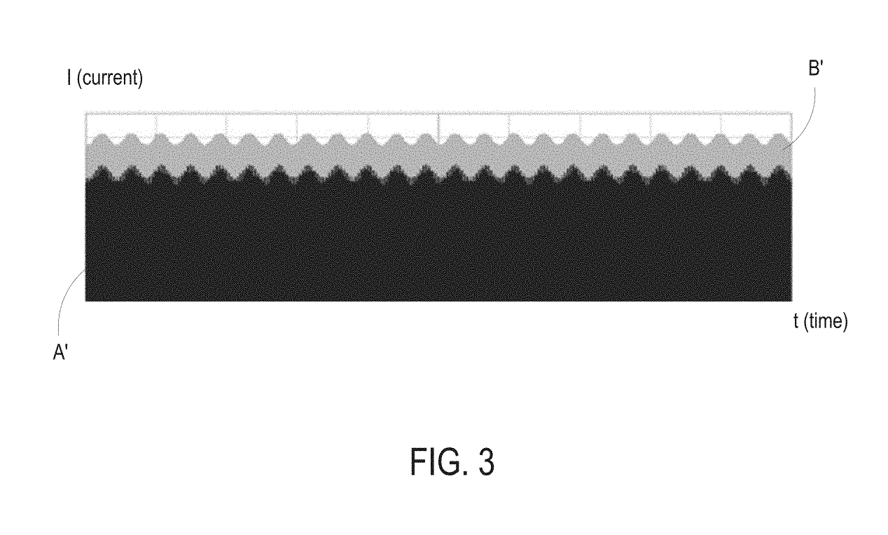

FIG. 2 is a schematic simulated waveform diagram illustrating the current of the lamp tube of the first lamp string or the second lamp string connected to the shared first filament preheating coil and the current of the other lamp tubes, in which the first inverter and the second inverter shown in FIG. 1 are asynchronously operated at the identical frequency. FIG. 3 is a schematic simulated waveform diagram illustrating the current of the lamp tube of the first lamp string or the second lamp string connected to the shared first filament preheating coil and the current of the other lamp tubes, in which the first inverter and the second inverter shown in FIG. 1 are asynchronously operated at different frequencies.

Please refer to FIG. 2. In this situation, the frequency of the first inverter 12 and the frequency of the second inverter 13 are identical. Because of the tolerances of the electronic components of the first inverter 12 and the second inverter 13 or other factors, the first inverter 12 and the second inverter 13 are asynchronously operated. That is, there is a phase difference between the first inverter 12 and the second inverter 13. Consequently, during operations at higher frequency, the current of the first lamp tube 100 or the second lamp tube 110 that is connected with the first filament preheating coil 14 is subjected to distortion in comparison with the other lamp tube. As shown in FIG. 2, in the current waveform of first lamp tube 100 or the second lamp tube 110 that is connected with the first filament preheating coil 14 (see reference symbol A in FIG. 2), each wave contains a single irregular low-frequency envelope. As mentioned above, the frequency of the first inverter 12 and the frequency of the second inverter 13 are identical. Due to the single irregular low-frequency envelope, the current waveform of the first lamp tube 100 or the second lamp tube 110 that is connected with the first filament preheating coil 14 cannot match the current waveform of the other lamp tube (see reference symbol B in FIG. 2). Under this circumstance, the first lamp tube 100 or the second lamp tube 110 that is connected with the first filament preheating coil 14 has a lamp flicker problem.

For solving the lamp flicker problem, there is a frequency difference between the frequency of the first inverter 12 and the frequency of the second inverter 13. The frequency difference is in the range between 500 Hz and 5 kHz, and preferably 1.2 kHz. That is, even if the first inverter 12 and the second inverter 13 are asynchronously operated, the frequency difference between the frequency of the first inverter 12 and the frequency of the second inverter 13 is in the range between 500 Hz and 5 kHz.

Please refer to FIG. 3. In this situation, the frequency of the first inverter 12 and the frequency of the second inverter 13 are different. In the current waveform of first lamp tube 100 or the second lamp tube 110 that is connected with the first filament preheating coil 14 (see reference symbol A′ in FIG. 3), each wave contains plural regular low-frequency envelopes (i.e., carrier waves). Consequently, in the current waveform of first lamp tube 100 or the second lamp tube 110 that is connected with the first filament preheating coil 14, each wave of FIG. 3 can be considered as the integrated wave of plural waves of FIG. 2. Consequently, the current waveform of the first lamp tube 100 or the second lamp tube 110 that is connected with the first filament preheating coil 14 can match the current waveform of the other lamp tube (see reference symbol B′ in FIG. 3). Under this circumstance, the first lamp tube 100 or the second lamp tube 110 that is connected with the first filament preheating coil 14 will not result in the lamp flicker problem.

In an example, the frequency of the AC voltage is 60 Hz. After the AC voltage is rectified and filtered, the frequency of the operating voltages provided to the first inverter 12 and the second inverter 13 of the electronic ballast system for signage light 1 is 120 Hz. If the frequency difference between the frequency of the first inverter 12 and the frequency of the second inverter 13 is 1.2 kHz (i.e., 1.2 k/120=10), each wave in the current waveform of first lamp tube 100 or the second lamp tube 110 that is connected with the first filament preheating coil 14 can be considered as the integrated wave containing ten 120 Hz-carrier waves. Consequently, the current waveform of the first lamp tube 100 or the second lamp tube 110 that is connected with the first filament preheating coil 14 can match the current waveform of the other lamp tube. Under this circumstance, the first lamp tube 100 or the second lamp tube 110 that is connected with the first filament preheating coil 14 will not result in the lamp flicker problem.

As mentioned above, the first lamp string 10 and the second lamp string 11 of the electronic ballast system for signage light 1 are connected with each other in series. Consequently, the ways of wiring the first lamp string 10 and the second lamp string 11 of the electronic ballast system for signage light 1 are similar to the ways of wiring the plural lamp tubes that are driven by the conventional inductive ballast. In other words, the conventional inductive ballast can be replaced by the electronic ballast system for signage light 1 of the present invention. In the electronic ballast system for signage light 1, the first lamp string 10 is driven by the first inverter 12, and the second lamp string 11 is driven by the second inverter 13. When compared with the conventional electronic ballast using the single inverter to drive all lamp tubes, the ignition voltages outputted from the first inverter 12 and the second inverter 13 of the electronic ballast system for signage light 1 are reduced. Consequently, the volume of the magnetic element (e.g., a transformer or an inductor) in the electronic ballast system for signage light 1 is reduced, and the electronic ballast system for signage light 1 can meet the miniaturization requirements of the modern electronic product. Moreover, the frequency difference between the frequency of the first inverter 12 and the frequency of the second inverter 13 is adjusted by the electronic ballast system for signage light 1. That is, even if no additional circuit is used or the circuitry is not modified, the first lamp tube 100 or the second lamp tube 110 that is connected with the first filament preheating coil 14 does not result in the lamp flicker problem.

Please refer to FIG. 1 again. The circuitry of the first inverter 12 is similar to the circuitry of the second inverter 13. For example, the first inverter 12 and the second inverter 13 are half-bridge resonant non-isolated inverters. Each of the first inverter 12 and the second inverter 13 comprises a half-bridge switching circuit 15, a resonant circuit 16 and a control unit 17. The resonant circuit 16 of the first inverter 12 or the second inverter 13 is electrically connected with the corresponding half-bridge switching circuit 15 and the corresponding lamp string. The control unit 17 of the first inverter 12 or the second inverter 13 is electrically connected with the corresponding half-bridge switching circuit 15 to control operations of the half-bridge switching circuit 15. Consequently, the corresponding resonant circuit 16 is subjected to resonance oscillation to output the corresponding electric energy to drive illumination of the corresponding lamp string.

Please refer to FIG. 1 again. In the first lamp string 10, one second filament preheating coil 18 is shared by every two adjacent first lamp tubes 100. In the second lamp string 11, one third filament preheating coil 19 is shared by every two adjacent second lamp tubes 110.

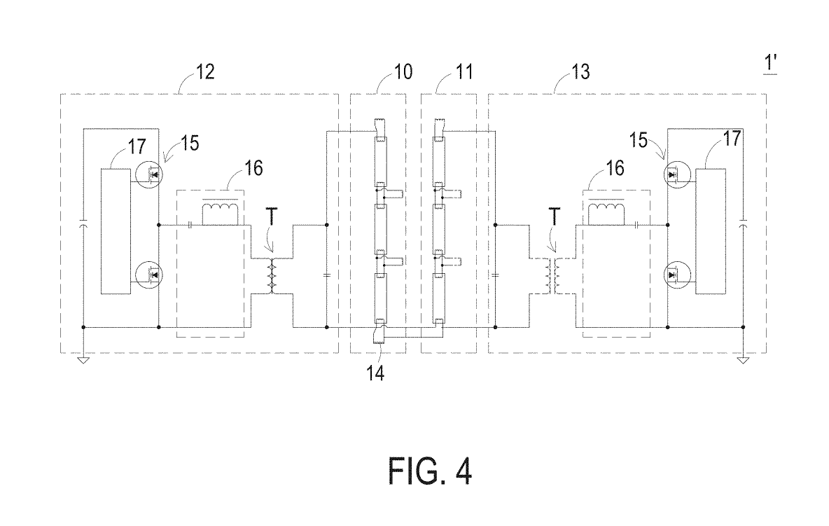

FIG. 4 is a schematic circuit block diagram illustrating a variant example of the electronic ballast system for signage light of FIG. 1. In this embodiment, the first inverter 12 and the second inverter 13 of the electronic ballast system for signage light 1′ are half-bridge resonant isolated inverters. Each of the first inverter 12 and the second inverter 13 comprises a half-bridge switching circuit 15, a resonant circuit 16, a control unit 17 and an isolated transformer T. The isolated transformer T is connected between the corresponding resonant circuit 16 and the corresponding lamp string so as to adjust the received voltage level.

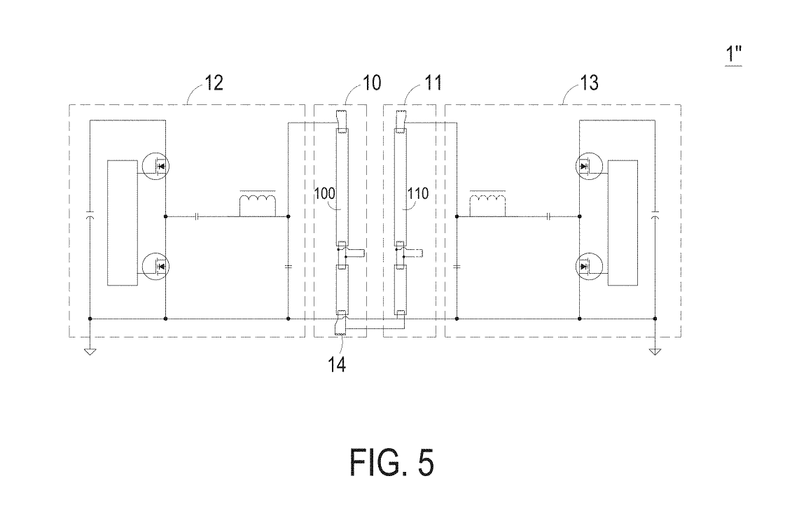

FIG. 5 is a schematic circuit block diagram illustrating another variant example of the electronic ballast system for signage light of FIG. 1. In comparison with FIG. 1, the number of the first lamp tubes 100 in the first lamp string 10 and the number of the second lamp tubes 110 of the second lamp string 11 are distinguished. In the electronic ballast system for signage light 1″ of FIG. 5, the first lamp string 10 comprises two first lamp tubes 100, and the second lamp string 11 comprises two second lamp tubes 110. Certainly, the number of the first lamp tubes 100 in the first lamp string 10 can be different from the number of the second lamp tubes 110 of the second lamp string 11.

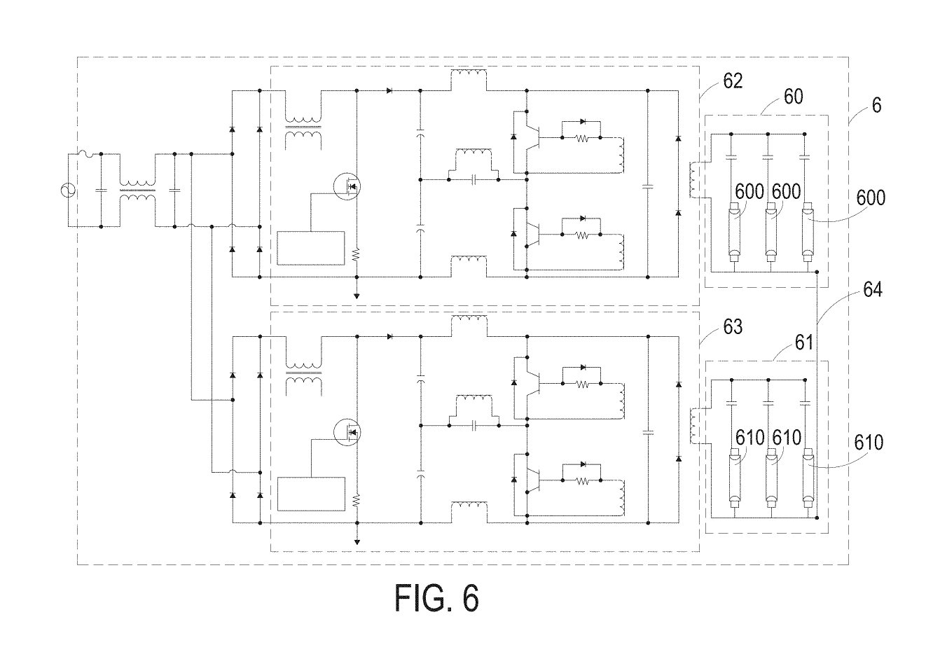

FIG. 6 is a schematic circuit block diagram illustrating an electronic ballast system for signage light according to another embodiment of the present invention. In this embodiment, the electronic ballast system for signage light 6 comprises a first lamp string 60, a second lamp string 61, a first inverter 62 and a second inverter 63. The first lamp string 60 comprises at least one first lamp tube 600. As shown in FIG. 6, the first lamp string 60 comprises three first lamp tubes 600 connected in parallel. The second lamp string 61 is connected with the first lamp string 60 in series. The second lamp string 61 comprises at least one second lamp tube 610. As shown in FIG. 6, the second lamp string 61 comprises three second lamp tubes 610. Moreover, an end of the second lamp string 61 is electrically connected with an end of the first lamp string 60 through a connection line 64.

The first inverter 62 is electrically connected with the first lamp string 60 for driving illumination of the first lamp string 60. The second inverter 63 is electrically connected with the second lamp string 61 for driving illumination of the second lamp string 61. In this embodiment, the first inverter 62 and the second inverter 63 are connected with each other in parallel, and preferably the first inverter 62 and the second inverter 63 are self-excitation half-bridge parallel resonant circuits, respectively. Preferably but not exclusively, the operating frequency of the first inverter 62 is 40 KHz and the operating frequency of the second inverter 63 is 41.2 KHz.

In this embodiment, for avoiding the asynchronous operation of the first inverter 62 and the second inverter 63 causing the lamp flicker problem of the first lamp tube 600 or the second lamp tube 610, there have to be a frequency difference between the frequency of the first inverter 62 and the frequency of the second inverter 63. The frequency difference is in the range between 500 Hz and 5 kHz, and preferably 1.2 kHz, but not limited.

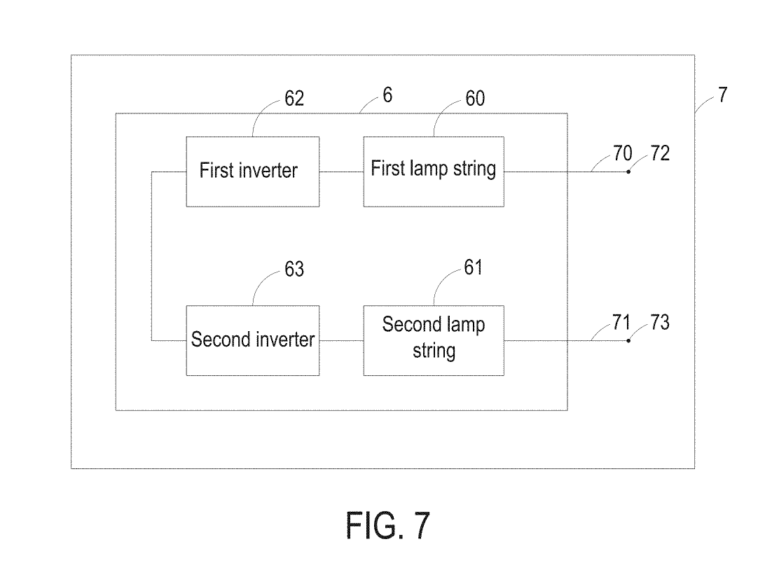

Certainly, the electrical connection between the end of the second lamp string 61 and the end of the first lamp string 60 is not limited to rely on the connection line 64. In some embodiments, as shown in FIG. 7, one end of the second lamp string 61 is connected with a first contact 72 of a circuit board 7 via a first connection line 70, where the electronic ballast system for signage light 6 is mount on the circuit board 7. One end of the second string 61 is connected with a second contact 73 of the circuit board 7 through a second connection line 71. Moreover, the first contact 72 and the second contact 73 is electrically connected with each other by the jump wire or the trace on the circuit board 7.

From the above descriptions, the present invention provides the electronic ballast system for signage light. The electronic ballast system for signage light can replace the conventional inductive ballasts. The first lamp string is driven by the first inverter, and the second lamp string is driven by the second inverter. Consequently, the volume of the magnetic element in the electronic ballast system is reduced, and the electronic ballast system can meet the miniaturization requirements of the modern electronic product. Moreover, due to the frequency difference between the frequency of the first inverter and the frequency of the second inverter, the first lamp tube or the second lamp tube that is connected with the first filament preheating coil does not result in the lamp flicker problem.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic ballast system for signage light, comprising:
a first lamp string comprising at least one first lamp tube;
a second lamp string connected with the first lamp string in series, and comprising at least one second lamp tube;
a first inverter electrically connected with the first lamp string for driving illumination of the first lamp string; and
a second inverter electrically connected with the second lamp string for driving illumination of the second lamp string,
wherein a frequency difference between a frequency of the first inverter and a frequency of the second inverter is in a range between 500 Hz and 5 kHz.

2. The electronic ballast system for signage light according to claim 1, wherein the first lamp string is connected with the second lamp string in series, and a first filament preheating coil is shared by one of the at least one first lamp tube of the first lamp string and one of the at least one second lamp tube of the second lamp string.

3. The electronic ballast system for signage light according to claim 2, wherein the first inverter and the second inverter are half-bridge resonant non-isolated inverters.

4. The electronic ballast system for signage light according to claim 2, wherein the first inverter and the second inverter are half-bridge resonant isolated inverters.

5. The electronic ballast system for signage light according to claim 2, wherein the frequency difference between the frequency of the first inverter and the frequency of the second inverter is 1.2 kHz.

6. The electronic ballast system for signage light according to claim 2, wherein the at least one first lamp tube of the first lamp string comprises plural serially-connected first lamp tubes, and the at least one second lamp tube of the second lamp string comprises plural serially-connected second lamp tubes.

7. The electronic ballast system for signage light according to claim 6, wherein one second filament preheating coil is shared by every two adjacent first lamp tubes, and one third filament preheating coil is shared by every two adjacent second lamp tubes.

8. The electronic ballast system for signage light according to claim 1, wherein the at least one first lamp tube of the first lamp string comprises plural parallel-connected first lamp tubes, and the at least one second lamp tube of the second lamp string comprises plural parallel-connected second lamp tubes.

9. The electronic ballast system for signage light according to claim 8, wherein one end of the second lamp string is electrically connected with one end of the first lamp string through a connection line.

10. The electronic ballast system for signage light according to claim 9, wherein the first inverter and the second inverter are self-excitation half-bridge parallel resonant circuits.

11. The electronic ballast system for signage light according to claim 9, wherein the frequency difference between the frequency of the first inverter and the frequency of the second inverter is 1.2 kHz.

12. The electronic ballast system for signage light according to claim 8, wherein the electronic ballast system for signage light is mounted on a circuit board, and wherein one end of the first lamp string is electrically connected with a first contact of the circuit board through a first connection line, one end of the second lamp string is electrically connected with a second contact of the circuit board through a second connection line, and the first contact and the second contact is electrically connected with each other by a jump wire or a trace on the circuit board.

13. An electronic ballast system for signage light, comprising:
a first lamp string comprising at least one first lamp tube;
a second lamp string connected with the first lamp string in series, and comprising at least one second lamp tube, wherein a first filament preheating coil is shared by one of the at least one first lamp tube of the first lamp string and one of the at least one second lamp tube of the second lamp string;
a first inverter electrically connected with the first lamp string for driving illumination of the first lamp string; and
a second inverter electrically connected with the second lamp string for driving illumination of the second lamp string,
wherein there is a frequency difference between a frequency of the first inverter and a frequency of the second inverter.

14. The electronic ballast system for signage light according to claim 13, wherein the frequency difference between the frequency of the first inverter and the frequency of the second inverter is in a range between 500 Hz and 5 kHz.

15. An electronic ballast system for signage light, comprising:
a first lamp string comprising at least one first lamp tube;
a second lamp string connected with the first lamp string in series, and comprising at least one second lamp tube, wherein a first filament preheating coil is shared by one of the at least one first lamp tube of the first lamp string and one of the at least one second lamp tube of the second lamp string;
a first inverter electrically connected with the first lamp string for driving illumination of the first lamp string; and
a second inverter electrically connected with the second lamp string for driving illumination of the second lamp string,
wherein there is a frequency difference between a frequency of the first inverter and a frequency of the second inverter, and the first inverter and the second inverter are half-bridge isolated inverters.

16. The electronic ballast system for signage light according to claim 15, wherein the frequency difference between the frequency of the first inverter and the frequency of the second inverter is in a range between 500 Hz and 5 kHz.
